(19) United States
(12) Patent Application Publication
(10) Pub. No.: US 2026/0242189 A1
(43) Pub. Date: Aug. 20, 2026

(54) Winch with automatic speed-changing mechanism

(71) Applicant: Zhejiang Normal University, Jinhua (CN)

(72) Inventors: Ying DONG, Jinhua (CN); Zhanhui CHANG, Jinhua (CN)

(21) Appl. No.: 19/641,639

(22) Filed: Apr. 8, 2026

(30) Foreign Application Priority Data
May 27, 2025 (CN) 202510687530.6

(51) Int. Cl. B66D 1/22

(52) U.S. Cl. CPC B66D 1/225

(57) ABSTRACT

The present disclosure provides an automatic speed-changing winch capable of autonomous clutch engagement and disengagement, as well as automatic speed adjustment based on different load. The winch autonomously allows the drum and gear mechanism to engage and disengage via a contact clutch. The gear mechanism automatically selects different transmission ratios based on the load on the drum: a smaller transmission ratio and higher speed under lower loads, and a larger transmission ratio and stronger load capacity under higher loads. This automatic speed-changing winch of the present disclosure can achieve these functions entirely mechanically, or through a combination of mechanical structure and electromagnetic control.

### CROSS-REFERENCE TO RELATED APPLICATION

This application claims priority to Chinese Patent Application No. 202510687530.6, filed on May 27, 2025, titled “Winch with automatic speed-changing mechanism” before the China National Intellectual Property Administration, the disclosure of which is incorporated herein by reference in entirety.

### TECHNICAL FIELD

The present disclosure relates to the field of transmission or traction equipment, and in particular to a winch with automatic speed-changing mechanism.

### BACKGROUND

A winch, driven by a power source, winds a rope around a drum to achieve pulling or lifting of heavy objects. Depending on the power source, winches are classified as manual, electric, hydraulic, and pneumatic. Winches have a wide range of applications. Most winches do not have speed-changing capabilities, and those that do require manual or remote control operation to achieve the desired speed, making them relatively inconvenient to use. Furthermore, because winch's transmission ratios are typically large, releasing the rope via a power source is slow and inefficient.

### SUMMARY

The purpose of the present disclosure is to at least partially overcome the shortcomings of the prior art and provide an automatic speed-changing winch that can automatically adjust the transmission ratio according to different working conditions, using a small transmission ratio under low load and a large transmission ratio under high load.

The present disclosure also aims to provide a winch with autonomous clutch, in which the drum disengages when actively pulling and releasing the rope, allowing free control of the pulling speed, and the drum engages when retracting the rope and when releasing the rope under load, effectively improving work efficiency.

To achieve the above-mentioned objectives or one of them, the technical solutions of the present disclosure are as follows:

A winch with automatic speed-changing mechanism, wherein the winch comprises a speed-changing assembly, a fixing member, a friction clutch, a friction clutch control mechanism, and a clutch device; the speed-changing assembly comprises a speed-changing input element and a speed-changing output element; the friction clutch is disposed in the speed-changing assembly and configured to enable the speed-changing input element and the speed-changing output element of the speed-changing assembly to rotate at the same or different speeds; the friction clutch control mechanism is configured to enable the friction clutch to disengage when exceeding a given load and to engage when below the given load; the clutch device is disposed between the speed-changing assembly and the fixing member of the winch and configured to enable engagement and disengagement of components of the speed-changing assembly with the fixing member.

According to some embodiments of the present disclosure, it further comprises a power transmission assembly and a contact clutch; the power transmission assembly comprises a power input component and a power output component; the contact clutch is disposed in the power transmission assembly and connects the power input component and the power output component of the power transmission assembly; the contact clutch is configured to disengage the power output component from the power input component, and to engage the power output component with the power input component when the power input component rotates actively; the power transmission assembly comprises a connection between the actuating element and the speed changing input element of the speed changing assembly, a connection between the speed-changing output element of the speed-changing assembly and the speed-changing input element of the next-stage speed-changing assembly, and a connection between the speed-changing output element of the speed-changing assembly and the drum of the winch. Specifically, the power transmission assembly refers to the connection of power components in the winch other than the speed-changing assembly, including the connection between the actuator and the speed-changing input element of the first-stage speed-changing assembly, the connection between the speed-changing output element of the first-stage speed-changing assembly and the speed-changing input element of the second-stage speed-changing assembly, the connection between the speed-changing output element of the second-stage speed-changing assembly and the speed-changing input element of the third-stage speed-changing assembly, etc., that is, the connection between the speed-changing output element of the previous-stage speed-changing assembly and the speed-changing input element of the next-stage speed-changing assembly, and the connection between the speed-changing output element of the last-stage speed-changing assembly and the drum.

According to some embodiments of the present disclosure, the speed-changing assembly is a planetary gear mechanism, comprising a sun gear, a ring gear, and a planet carrier; the speed-changing input element is the sun gear, and the speed-changing output element is the planet carrier or the ring gear.

Specifically, the friction clutch is located in the planetary gear mechanism, connecting the sun gear and the planet carrier, or connecting the planet carrier and the ring gear, or connecting the sun gear and the ring gear.

According to some embodiments of the present disclosure, the friction clutch control mechanism comprises an elastic element A, a combination feature, and a curved surface feature; the combination feature comprises a straight segment with a straight generatrix and/or a curved segment with a curved generatrix, the combination feature being configured such that when the elastic element A enters and/or leaves the curved segment, the elastic element A undergoes elastic deformation; the curved surface feature is configured to generate axial force during rotation.

The friction clutch control mechanism controls the engagement and disengagement of the friction clutch. Specifically, when the drum load is high, the curved surface feature generates a large axial force. This force overcomes the elastic force of the elastic element A through the combination feature, causing the component to push the friction clutch to disengage. When the drum load is low, the axial force generated by the curved surface feature is insufficient to overcome the elastic force of the elastic element A, and the friction clutch remains engaged. The elastic element A ensures that the friction clutch is fully engaged under low loads, unaffected by the friction clutch control mechanism. This avoids the risk of unreliable engagement and slippage failure of the friction clutch under low loads due to the axial force constantly generated by the curved surface feature and applied to the friction clutch always.

According to some embodiments of the present disclosure, the clutch device is a one-way clutch or an electromagnetically controlled locking pin device. The one-way clutch can be a roller-groove type (roller-and-ramp type) one-way clutch, a wedge type (sprag-type) one-way clutch, or a ratchet mechanism, etc. The electromagnetically controlled locking pin device is an electromagnetically driven locking pin that is inserted into a component of the speed-changing assembly to fix the component, or that separates from the component, freeing the component. The component of the speed-changing assembly connected to the clutch device can be a gear ring or a planetary carrier.

According to some embodiments of the present disclosure, the contact clutch comprises a control bracket and a locking block; the control bracket is frictionally connected to the fixing member, the control bracket has a groove, an outer end of the locking block passes through the groove and is rotatable around an inner end of the locking block; the locking block is configured to simultaneously contact the power input component and the power output component so that the contact clutch is engaged when the locking block rotated to a first position, and configured not to contact the power output component or the power input component so that the contact clutch is disengaged when the locking block rotated to a second position.

According to some embodiments of the present disclosure, the friction clutch comprises a friction plate, a pressure plate and an elastic element B, the elastic element B causes the pressure plate to press against the friction plate, and the pressure plate and the friction plate are respectively circumferentially fixedly connected to different components of the speed-changing assembly.

According to some embodiments of the present disclosure, the fixing member comprises a housing of the winch fixedly installed, and parts directly or indirectly fixedly connected to the housing.

According to some embodiments of the present disclosure, the contact clutch comprises a locking block and a return spring; the return spring causes the locking block to tend to move inward toward the power input component; the locking block is configured to simultaneously contact the power input component and the power output component so that the contact clutch is engaged when the locking block situated in an outer position, and configured not to contact the power output component or the power input component so that the contact clutch is disengaged when the locking block situated in an inner position.

The winch of the present disclosure has the following advantages:

The winch of the present disclosure automatically adjusts its speed according to the load, requiring no manual intervention: When the load is low, the winch automatically operates at a small transmission ratio, resulting in high speed and efficiency; when the load is high, it automatically switches to a large transmission ratio to meet the work requirements. The transmission ratio switching process is completed automatically, requiring no manual intervention.

The load value where switching is done can be accurately set, and there is no slippage phenomenon: Through the action of elastic element A in the friction clutch control mechanism, the friction clutch can be fully engaged when the drum load is below a certain value, and completely disengaged when it exceeds this specific value. There will be no slippage caused by a force acting on the friction clutch while the friction clutch is engaged.

The system allows for switching between free and controlled rope release as needed: When rapid rope release is required, the clutch disengages, allowing the drum to rotate freely and the user to control the release speed. When controlled rope release is required, the clutch engages, enabling controlled rope release under load. During rope winding/retraction operated by the actuator, the clutch engages, and the winch winds up the rope quickly or slowly depending on the load.

### BRIEF DESCRIPTION OF THE DRAWINGS

FIG. 1 is a schematic view of a winch with autonomous clutch and automatic speed-changing according to Embodiment 1 of the present disclosure;

FIG. 2 is a schematic view of the clutch device, friction clutch, and friction clutch control mechanism in Embodiment 1;

FIG. 3 is a schematic view of the installation of the contact clutch in Embodiment 1;

FIG. 4 is an axial schematic view of the contact clutch structure and principle in Embodiment 1;

FIG. 5 is a schematic view of the clutch device and friction clutch control mechanism according to Embodiment 2 of the present disclosure;

FIG. 6 is a schematic view of the friction clutch and friction clutch control mechanism according to Embodiment 3 of the present disclosure;

FIG. 7 is a schematic view of the friction clutch, friction clutch control mechanism, and contact clutch according to Embodiment 4 of the present disclosure;

FIG. 8 is a schematic view of the combination feature in the friction clutch control mechanism;

FIG. 9 is a schematic view of the contact clutch according to Embodiment 5 of the present disclosure.

### DETAILED DESCRIPTION OF EMBODIMENTS

Exemplary embodiments of the present disclosure are described in detail below with reference to the accompanying drawings, wherein the same or similar reference numerals denote the same or similar elements. Furthermore, in the following detailed description, numerous specific details are set forth for ease of explanation to provide a thorough understanding of the embodiments disclosed herein. However, it will be apparent that one or more embodiments may be practiced without these specific details. In other instances, well-known structures and apparatuses are illustrated to simplify the drawings.

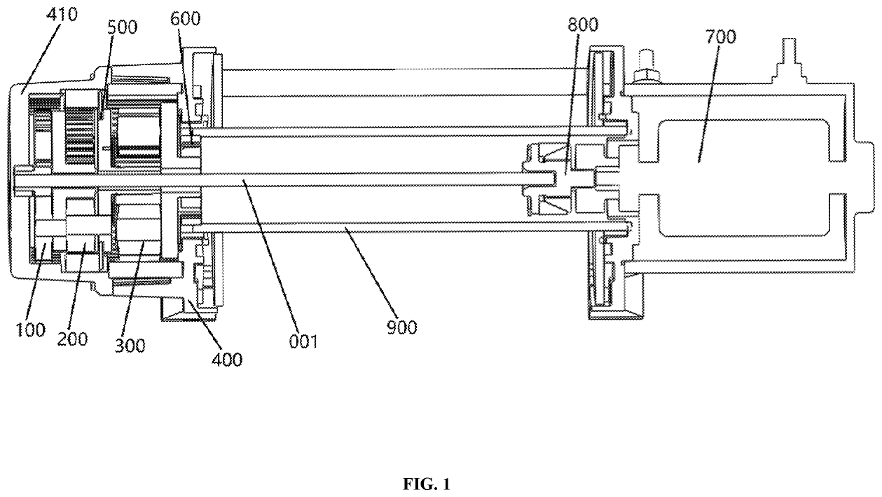

FIGS. 1-4 show a first embodiment of an automatic speed-changing winch using the solution of the present disclosure, which has an autonomous clutch function. The winch includes an actuating device (actuator) 700, a transmission and braking assembly 800, a drum assembly 900, an actuating element (actuator) 001 connected to the actuating device 700 via the transmission and braking assembly 800, a fixedly installed fixing member 400, and a housing 410 fixedly installed with the fixing member 400. The fixing member 400 and the housing 410 contain a gear transmission mechanism, a clutch device, a friction clutch, a friction clutch control mechanism, and a contact clutch, etc. The gear transmission mechanism includes the following speed-changing assemblies: a first-stage planetary gear mechanism 100, a second-stage planetary gear mechanism 200, and a third-stage planetary gear mechanism 300. A friction clutch 500 is disposed within the second-stage planetary gear mechanism 200. The friction clutch control mechanism is based on the components of the second-stage planetary gear mechanism 200 containing the friction clutch 500 and adjacent components. Curved surface feature, combination feature, and elastic element A are provided on these components to achieve control of the friction clutch 500. The power transmission assembly includes the connection between the actuating element 001 and the speed-changing assembly, the connection between the previous-stage speed-changing assembly and the next-stage speed-changing assembly, and the connection between the speed-changing assembly and the drum assembly 900, etc., and is divided into power input components and power output components according to the power transmission direction. In this embodiment, the contact clutch 600 is disposed in the power transmission assembly connected to the third-stage planetary gear mechanism 300 and the drum assembly 900. The planet carrier 330 of the third-stage planetary gear mechanism 300 is the transmission output element of the speed-changing assembly, serving as the power input component in this power transmission assembly. The drum assembly 900 is the power output component in this power transmission assembly.

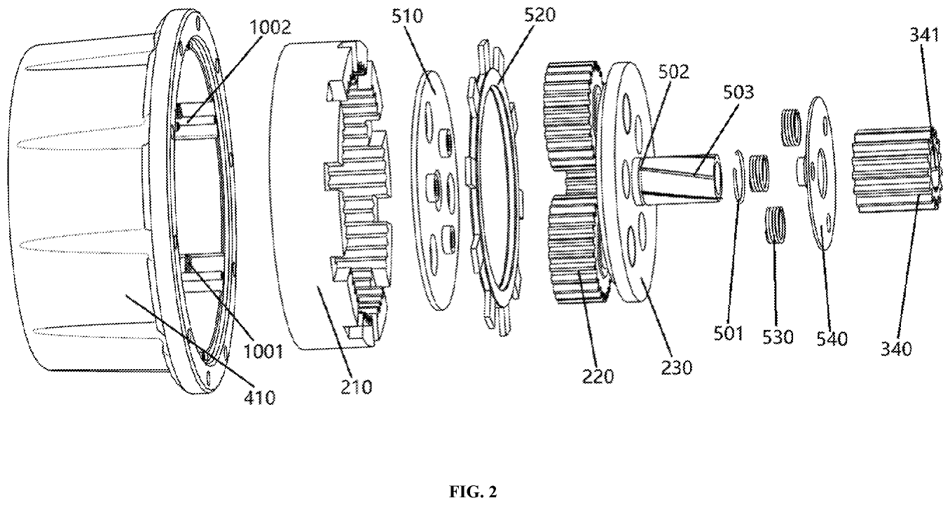

FIG. 2 shows the structure and principle of the clutch device 1000, friction clutch 500, and friction clutch control mechanism in Embodiment 1. The clutch device 1000 is a roller-groove type one-way clutch, including a groove on the housing 410, a roller 1002 installed in the groove, and a spring 1001 acting on the roller 1002. The spring 1001 causes the roller 1002 to tend to move towards the narrow end of the groove. The gear ring 210 of the second-stage planetary gear mechanism is installed inside the housing 410. Due to the action of the spring 1001, the outer surface of the gear ring 210 is always in contact with the roller 1002; therefore, the gear ring 210 can only rotate in one direction. A groove is provided in one side of the gear ring 210, it cooperates with the friction plate 520. The friction plate 520 is circumferentially fixedly connected to the gear ring 210, allowing the friction plate 520 and the gear ring 210 to rotate as a unit. The friction plate 520 has steel plates on both sides, or parts with the same function as the steel plates, such as the pressure plate 510 and the planetary carrier 230. The pressure plate 510 has a non-circular cross-section or flange feature that mates with the planetary carrier 230, so that the pressure plate 510 and the planetary carrier 230 are circumferentially fixed and rotate as a whole. The spring 530 is mounted on the planetary carrier 230, and its other end is limited by the end cover 540. The pressure plate 510 has a threaded hole, and the spring 530 is compressed by bolting the pressure plate. Pressure and friction are generated between the pressure plate 510 and the friction plate 520, and between the friction plate 520 and the planetary carrier 230. The pressure plate 510, the friction plate 520, the planetary carrier 230, the spring 530, and the pressure plate 540 together form a friction clutch 500, realizing the frictional connection between the gear ring 210 and the planetary carrier 230. As the spring 530 is compressed and deformed, there is pressure and friction between the friction plate 520, the pressure plate 510, and the planetary carrier 230, and the gear ring 210 and the planetary carrier 230 rotate as a unit; when the pressure plate 540 is moved to the left to further compress the spring 530, the pressure plate 510 leaves the surface of the friction plate 520, the friction clutch 500 disengages, then the gear ring 210 and the planetary carrier 230 can rotate separately.

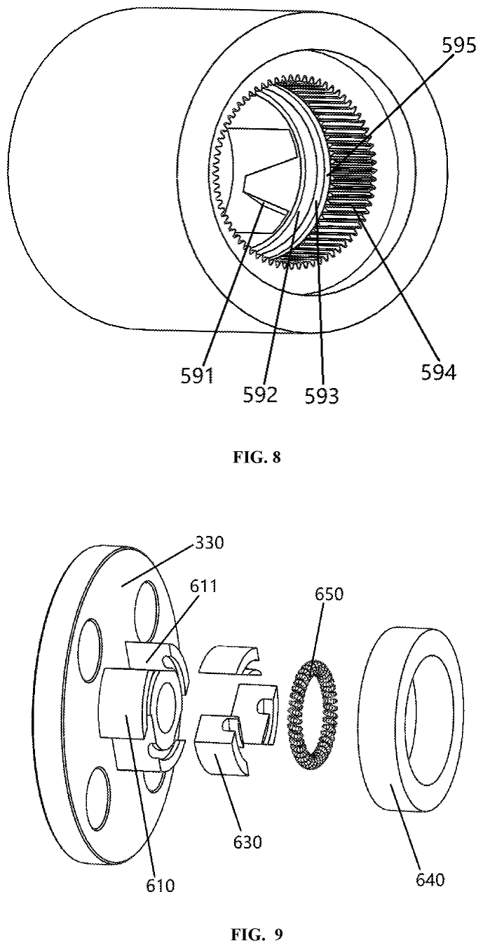

The planetary carrier 230 is connected to the transmission input element of the next speed-changing assembly, namely the sun gear 340 of the third-stage planetary gear mechanism, via a journal. The journal, fixedly connected to the planetary carrier 230, has an oblique groove 503 as curved surface feature and an annular groove 502. The inner bore of the sun gear 340, which mates with the journal, has an oblique boss 341 that matches the oblique groove 503. The sun gear 340 is a spur gear. The elastic element A is an annular open spring 501, disposed in the annular groove 502. The natural inner diameter of the open spring 501 is smaller than the diameter of the journal containing the annular groove 502; that is, when the open spring 501 is installed in the annular groove 502, it cannot fully contact the annular groove 502 in its natural state. The inner bore of the sun gear 340 includes a combination feature on the side facing the friction clutch, consisting of a straight segment with a straight generatrix and a curved segment with a curved generatrix, as shown in FIG. 8. The inner diameter of the large-diameter portion of the straight segment is close to the outer diameter of the open spring 501 in its natural state; the inner diameter of the small-diameter portion of the straight segment is close to the outer diameter of the open spring 501 when it is pressed into the annular groove 502. The curved segment serves as a transition between the large-diameter and small-diameter straight segments. Depending on the specific design requirements, the lengths of the large-diameter and small-diameter straight segments can be set as needed, or even eliminated. The generatrix of the curved segment can be a straight line, a circular arc, a hyperbola, a parabola, or a combination of the above curves.

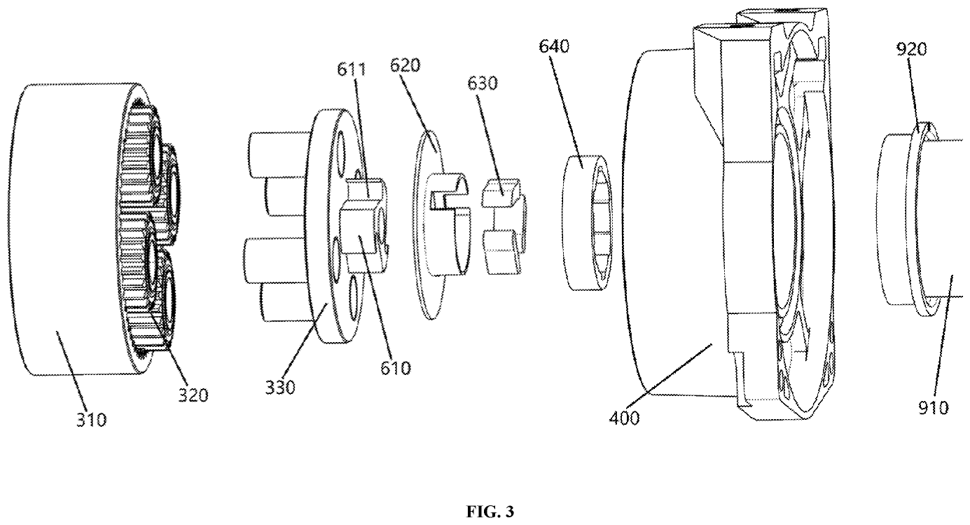

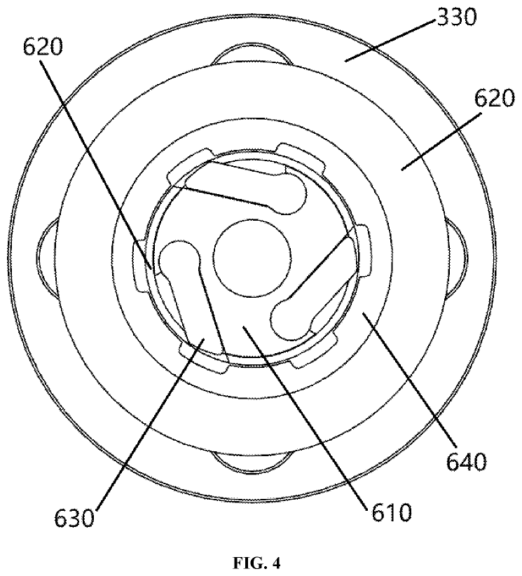

FIGS. 3 and 4 show the contact clutch 600 disposed between the third-stage planetary gear mechanism 300 and the drum assembly 900. The connection between the planetary carrier 330, the speed-changing output element of the third-stage planetary gear mechanism 300, and the drum assembly 900 forms a power transmission assembly. The planetary carrier 330 is the power input component, and the outer ring 640, which is fixedly installed with the drum assembly 900, is the power output component. The inner element 610 of the contact clutch 600 is fixedly installed with the planetary carrier 330, the control bracket 620 is frictionally installed with the fixing member 400, and the outer ring 640 is fixedly installed inside the drum 910 of the drum assembly 900. The inner element 610 has a groove 611 containing a partially circular hole. The inner end of the locking block 630 has a cylindrical surface that mates with the partially circular hole in the groove 611. The outer end extends out of the outer surface of the inner element 610 and is inserted into the groove of the control bracket 620. The inner surface of the outer ring 640 has a groove that matches the protruding end of the locking block 630. The control bracket 620 includes a portion with the groove feature, the outer diameter of which is smaller than the minimum inner diameter of the outer ring 640, and the inner diameter of which is larger than the outer diameter of the inner element 610. The locking block 630 is rotatable about its cylindrical mounting end. FIG. 4 shows the second position of the locking block 630, where its outer end is inserted into the groove of the control bracket 620, and its outer surface does not exceed the outer surface of the control bracket 620. The locking block 630 does not contact the power output component 640, and the contact clutch 600 is disengaged. The locking block 630 rotates clockwise about its cylindrical mounting end, and its first position is when its outer end is inserted into the groove of the outer ring 640. At this time, the locking block 630 simultaneously contacts the power input component 330 and the power output component 640, and the contact clutch 600 is engaged.

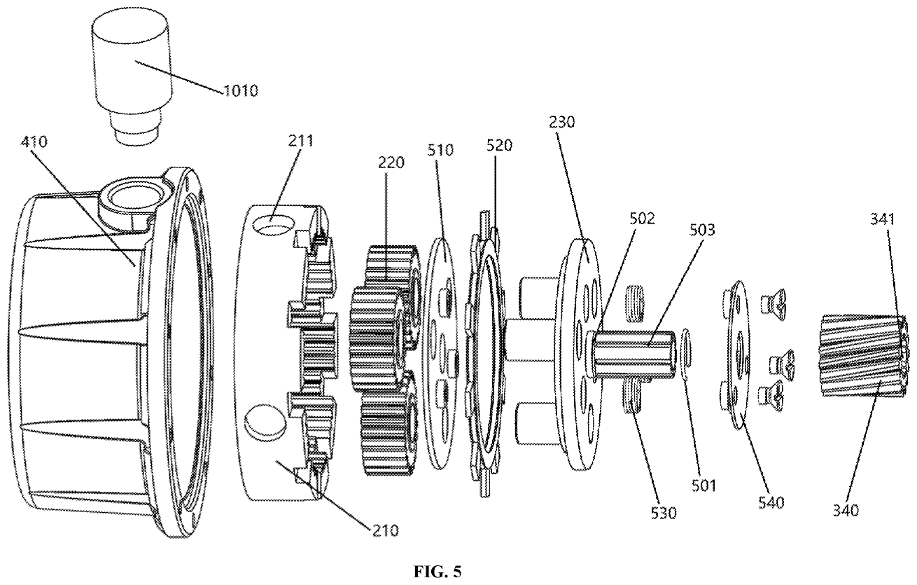

FIG. 5 shows a second embodiment of the clutch device and friction clutch control mechanism, which differs from the first embodiment in that:

The clutch mechanisms differ: In Embodiment 1, the clutch mechanism is a one-way clutch; in Embodiment 2, the clutch mechanism is an electromagnetically controlled locking pin device. Specifically, an electromagnetic unit 1010 capable of controlling the locking pin is installed on the housing 410, and a groove 211 matching the locking pin is provided on the gear ring 210. When the electromagnetic unit 1010 controls the locking pin to the upper position, the gear ring 210 is separated from the housing 410, and the gear ring 210 can rotate freely; when the electromagnetic unit 1010 controls the locking pin to be inserted into the groove 211 at the lower position, the gear ring 210 is engaged with the housing 410, and the gear ring 210 cannot rotate.

The friction clutch control mechanism differs: In Embodiment 2, the friction clutch is the same as in Embodiment 1, also located in the second-stage planetary gear mechanism 200. However, the friction clutch control mechanism differs slightly, specifically in its curved surface features. In Embodiment 1, the curved surface feature of the friction clutch control mechanism is the mounting fit between the journal and the sun gear 340. The sun gear 340 is a spur gear, and axial force is generated during rotation through the engagement of the inclined groove 503 and the inclined boss 341. In Embodiment 2, the sun gear 340 is a helical gear. Therefore, the groove 503 on the journal and the boss 341 in the inner hole of the sun gear 340 are straight lines. The axial force generated when the helical gear rotates pushes the sun gear 340 to move, thereby controlling the friction clutch 500.

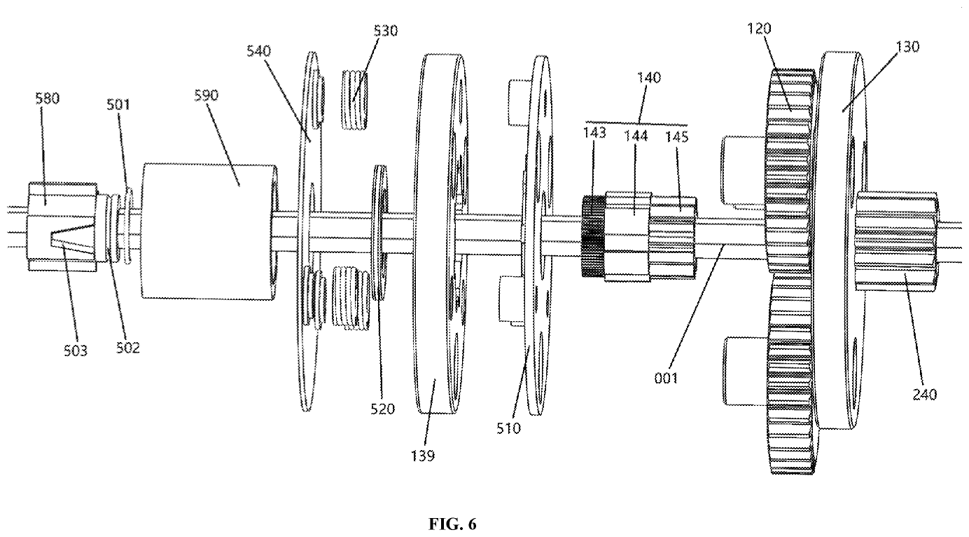

FIG. 6 shows a third embodiment of the friction clutch and its control mechanism. The friction clutch 500 is disposed within the first-stage planetary gear mechanism 100 and connects the sun gear 140 and the planet carrier 130. The corresponding friction clutch control mechanism is also based on the components of the first-stage planetary gear mechanism 100 and adjacent components. The sun gear 140 includes a spline portion 143, a non-circular cross-section portion 144, and a gear portion 145. The friction clutch 500 includes a pressure plate 510, a spring 530, an end cover 540, a friction plate 520, and a left side plate 139 of the planet carrier. The friction plate 520 engages with the non-circular cross-section portion 144 of the sun gear 140 via a non-circular cross-section, is circumferentially fixed, and rotates integrally. The pressure plate 510 engages with the left side plate 139 of the planet carrier via a flange feature, is circumferentially fixed, and rotates integrally. The end cover 540 is connected to the pressure plate 510 by threads, and the compression spring 530 causes pressure and friction to be generated on both sides of the friction plate 520.

Actuating element 001 is fixedly connected to inner transmission component 580. Inner transmission component 580 has a bidirectional curved surface feature 503 and an annular groove 502. Open spring 501 is installed in annular groove 502, the same as in Embodiment 1. Outer transmission component 590 is fitted outside inner transmission component 580. The inner hole includes a bidirectional curved surface feature 591 that matches bidirectional curved surface feature 503, a combination feature large-diameter straight segment 595, a combination feature curved segment 593, a combination feature small-diameter straight segment 592, and an internal spline 594 that mates with spline portion 143 of sun gear 140, as shown in FIG. 8.

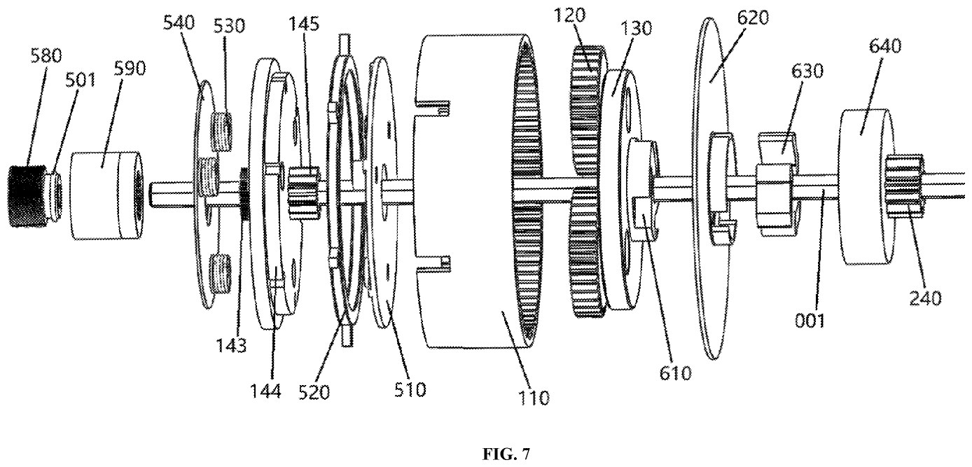

FIG. 7 shows a fourth embodiment of the friction clutch and its control mechanism, and the contact clutch. The contact clutch 600 is positioned between the planetary carrier 130, the output element of the first-stage planetary gear mechanism 100, and the sun gear 240, the input element of the second-stage planetary gear mechanism 200. The planetary carrier 130 serves as the power input, and the sun gear 240 as the power output. Its specific structure and principle are basically the same as in Embodiment 1, and will not be detailed here. The friction clutch 500 is located in the first-stage planetary gear mechanism 100, connecting the sun gear 140 and the ring gear 110. Here, the friction plate 520 is connected to the ring gear 110 and rotates integrally with it. The sun gear 140 includes a spline portion 143, a friction clutch support portion 144, and a gear portion 145. The pressure plate 510, spring 530, and end cover 540 are all mounted on the friction clutch support portion 144. Their specific structure and principle are similar to those in Embodiment 1, and will not be detailed here. The friction clutch control mechanism is similar to that of Embodiment 3, except that the curved surface features are different. Embodiment 3 uses a specially processed bidirectional curved surface feature, while this embodiment uses a slanted spline, which generates axial force when rotating.

FIG. 9 shows a fifth embodiment of the contact clutch. The contact clutch 600 is disposed between the planetary carrier 330, the speed-changing output element of the third-stage planetary gear mechanism 300, and the drum assembly 900. The planetary carrier 330 serves as the power input component, and the outer ring 640, which is fixedly connected to the drum assembly 900, serves as the power output component. The inner element 610 of the contact clutch 600 is fixedly installed with the planetary carrier 330. The inner element 610 has a wedge-shaped groove 611 to install a wedge-shaped locking block 630 with a cylindrical outer surface. On the surface of the inner element 610 and the wedge-shaped locking block 630 facing the drum assembly 900, an annular groove is also provided to install an annular return spring 650.

The working process of the winch with autonomous clutch and automatic speed-changing function in Embodiment 1 of the present disclosure is described below with reference to the combination features shown in FIGS. 1-4 and 8:

Actuation device 700 drives actuating element 001 to rotate via transmission and braking assembly 800. Actuating element 001 is connected to the sun gear 140 in the first-stage planetary gear mechanism 100, driving the sun gear 140 to rotate. The rotation is then transmitted to the second speed-changing assembly via the first speed-changing assembly. In the second-stage planetary gear mechanism 200, friction clutch 500 frictionally connects planet carrier 230 and ring gear 210. A one-way clutch 1000 is provided between ring gear 210 and housing 410. The sun gear 340 of the third-stage planetary gear mechanism 300 is connected to the planet carrier 230 via curved surface features—sloping groove 503/sloping boss 341. The connecting journal has an annular groove 502, on which an open spring 501 is mounted. The inner hole of the sun gear 340 facing the open spring 501 includes a combination feature, as shown in FIG. 8. The open spring 501 is located at the large end of the curved segment 593. There is a small gap or no pressure contact between the left end face of the sun gear 340 and the end cover 540 of the friction clutch 500. The connection between the planetary carrier 330, the speed-changing output element of the third-stage planetary gear mechanism 300, and the drum assembly 900 is a power transmission assembly, equipped with a contact clutch 600. The control bracket 620 is frictionally connected to the fixing member 400. The locking block 630 is hinged to the inner element 610 with its inner cylindrical end, and its outer end extends beyond the outer surface of the inner element 610, inserting into the groove of the control bracket 620. The outer ring 640 is fixedly installed inside the drum 910, and its inner ring has a groove. The protruding end of the locking block 630 can be inserted into this groove when the locking block 630 rotates to the first position. The gear ring 110 of the first-stage planetary gear mechanism 100 and the gear ring 310 of the third-stage planetary gear mechanism 300 are fixedly connected to the housing 410 and the fixing member 400, respectively.

When the drum assembly 900 needs to be separated/disengaged, if the locking block 630 is not at the second position, the actuating device 700 reverses, causing the inner element 610 to rotate clockwise (view from FIG. 4), and causing the inner end of the locking block 630 to rotate clockwise as well. The outer ring 640, which is fixedly connected to the drum assembly 900, remains stationary. Due to the friction between the control bracket 620 and the fixing member 400, the control bracket 620 tends to remain stationary, and the outer end of the locking block 630 inserted into the groove also tends to remain stationary. Therefore, the locking block 630 rotates inward around its supporting cylindrical end to the second position. At this time, the outer end of the locking block 630 is stuck in the groove of the control bracket 620, and its outer surface does not extend beyond the outer surface of the control bracket 630, and it is not in contact with the outer ring 640 at all, allowing the drum 900 to rotate freely.

When the drum assembly 900 needs to be engaged, the actuator 700 rotates forward, causing the inner element 610 and the inner end of the locking block 630 to rotate counterclockwise together. Since the control bracket 620 tends to be stationary, the groove of the control bracket 620 causes the protruding end of the locking block 630 to rotate in the opposite direction, that is, the locking block 630 rotates clockwise around its support end, opening outwards. When it rotates to the first position, the protruding end of the locking block 630 is inserted into the groove of the outer ring 640. Therefore, the inner element 610 drives the outer ring 640 to rotate together through the locking block 630, that is, the drum assembly 900 is engaged with the actuator.

When the winch is in operation, under no-load or light load, the actuator 700 rotates forward to wind up the rope, the first-stage planetary gear mechanism 100 operates normally, the ring gear 210 and planet carrier 230 of the second-stage planetary gear mechanism 200 rotates at the same speed due to the engagement of the friction clutch 500, rotating as a unit with the sun gear 240. The one-way clutch 1000 allows the ring gear 210 to rotate. The sun gear 340 and the planet carrier 230 are connected by a curved surface feature. The open spring 501 is located at the large end of the curved segment 593 of the combination feature. Due to the light load, the axial force generated by the curved surface feature is small and cannot deform the open spring 501 into the curved segment 593. Therefore, the sun gear 340 maintains its axial position and the friction clutch 500 is not affected by external forces. The contact clutch 600 engages due to the forward rotation of the actuator 700, the winch operates with the transmission ratio of the first speed-changing assembly superimposed on the transmission ratio of the third speed-changing assembly. The second speed-changing assembly, which is equipped with the friction clutch 500, does not change speed, the winch has a small transmission ratio, high speed, and high efficiency.

When the load exceeds a certain value, the axial force generated by the curved surface feature connecting the sun gear 340 and the planetary carrier 230 is large. Under the action of this axial force, the open spring 501 elastically deforms and enters the curved segment 593, causing the sun gear 340 to move to the left and eliminate the gap. When the open spring 501 enters the small-diameter straight segment, the sun gear 340 presses against the end cover 540, and the axial force acts almost entirely on the end cover 540, compressing the spring 530 and causing the friction clutch 500 to disengage. The ring gear 210 and the planetary carrier 230 can then operate at different speeds. At this time, since the planetary carrier 230 is a speed-changing output element connected to the load on the drum assembly 900, it has a tendency to stop, thus causing the ring gear 210 to have a tendency to reverse. The one-way clutch 1000 prevents the ring gear 210 from rotating in the opposite direction, thus enabling the second-stage planetary gear mechanism 200 to perform speed-changing transmission. The winch superimposes the transmission ratios of the three speed-changing assemblies, operating at the maximum transmission ratio, resulting in the maximum working torque. Due to the action of the open spring 501, the friction clutch 500 is completely unaffected by axial force when the winch load is below the given value, and when the winch load exceeds the given value, it is sufficient to disengage the friction clutch 500. Therefore, the friction clutch 500 will not slip under certain load conditions.

In Embodiment 2 shown in FIG. 5, the friction clutch 500 is the same as in Embodiment 1, except that the curved surface feature that generate axial force in the friction clutch control mechanism is different, but the working principle is the same. When the axial force generated by the helical gear 340 exceeds a certain value, compress the spring 530 to disengage the friction clutch 500. The major difference is that the clutch device has been changed from a one-way clutch in Embodiment 1 to an electromagnetically controlled locking pin device. When the load is small, the electromagnetic unit 1010 controls the locking pin to be in the upper position, and the gear ring 210 can rotate freely; when the load is large, the electromagnetic unit 1010 controls the locking pin to insert into the groove 211 on the gear ring 210, and the helical gear 340 moves to the left to press the end cover 540, causing the friction clutch 500 to disengage, and the second-stage planetary gear mechanism 200 to perform speed-changing transmission.

In Embodiment 3 shown in FIG. 6, the friction clutch 500 connects the sun gear 140 and planet carrier 130 of the first-stage planetary gear mechanism 100. The curved surface feature 503 of the friction clutch control mechanism can operate in both forward and reverse directions, and is a bidirectional curved surface feature. In Embodiment 4 shown in FIG. 7, the friction clutch 500 connects the sun gear 140 and ring gear 110 of the first-stage planetary gear mechanism 100. The curved surface feature of the friction clutch control mechanism is achieved by a slanted spline. In both embodiments, a clutch device (not shown in the figure) is provided between the ring gear 110 of the first-stage planetary gear mechanism 100 and the housing 410.

In the fourth embodiment shown in FIG. 7, the contact clutch 600 is also installed in the power transmission assembly that connects the transmission output element of the first speed-changing assembly and the transmission input element of the second speed-changing assembly. The control bracket 620 is frictionally connected to the fixing member 400 or the part that is fixedly connected to the fixing member 400. The outer ring 640 is fixedly connected to the sun gear 240. Its working principle is basically the same as that of the Embodiment 1, and will not be described in detail here.

FIG. 9 shows a fifth embodiment of the contact clutch 600. The return spring 650 causes the wedge-shaped locking block 630 to tend to move inward. When the wedge-shaped locking block 630 is at its innermost position, its outer surface does not exceed the outer surface of the inner element 610 and does not contact the outer ring 640, thus disengaging the contact clutch 600. When the inner element 610 rotates clockwise (viewed in FIG. 9), the wedge-shaped locking block 630 moves outward under the action of centrifugal force, overcoming the force of the return spring 650, and contacts the outer ring 640. Due to the friction generated by the centrifugal force on the arc-shaped contact surface, the wedge-shaped locking block 630 tends to move towards its smaller end. The friction on the outer surface and the supporting force on the supporting surface of the wedge-shaped groove 611 work together to make the wedge-shaped locking block 630 stuck between the inner element 610 and the outer ring 640, thus engaging the contact clutch 600. When the inner element 610 rotates counterclockwise, the friction on the outer surface of the wedge-shaped locking block 630 causes it to move toward the larger end. This, together with the supporting force on the other side of the wedge-shaped groove 611, causes the wedge-shaped locking block 630 to tend to move inward, making it impossible for the contact clutch 600 to reliably engage.

In other preferred embodiments of the present disclosure, the friction clutch 500 can be disposed within any speed-changing assembly and can act between any components of the speed-changing assembly. The contact clutch 600 can be disposed within any power transmission assembly. When the rope is released under load condition, the drum rotates actively, and the contact clutch 600 can reliably engage.

The above-mentioned working process, namely the transmission ratio change process and the drum engage/disengage process, can be fully realized automatically by mechanical means, or it can be realized by a combination of electromagnetic control and mechanical means. The winch can quickly take in the rope and release the rope freely in the no-load state, automatically adjust the transmission ratio according to the load size in the load state. Release the rope in the load state, or maintain the braking effect of the winch through the transmission and braking unit will not be affected.

Although embodiments of the present disclosure have been shown and described, it will be understood by those skilled in the art that variations may be made to these embodiments without departing from the principles and spirit of the present disclosure. The scope of the present disclosure is defined by the appended claims and their equivalents.

What is claimed is:

1. A winch with automatic speed-changing mechanism, wherein the winch comprises a speed-changing assembly, a fixing member, a friction clutch, a friction clutch control mechanism, and a clutch device; the speed-changing assembly comprises a speed-changing input element and a speed-changing output element; the friction clutch is disposed in the speed-changing assembly and configured to enable the speed-changing input element and the speed-changing output element of the speed-changing assembly to rotate at the same or different speeds; the friction clutch control mechanism is configured to enable the friction clutch to disengage when exceeding a given load and to engage when below the given load; the clutch device is disposed between the speed-changing assembly and the fixing member of the winch and configured to enable engagement and disengagement of components of the speed-changing assembly with the fixing member.

2. The winch with automatic speed-changing mechanism according to claim 1, wherein it further comprises a power transmission assembly and a contact clutch; the power transmission assembly comprises a power input component and a power output component; the contact clutch is disposed in the power transmission assembly and connects the power input component and the power output component of the power transmission assembly; the contact clutch is configured to disengage the power output component from the power input component, and to engage the power output component with the power input component when the power input component rotates actively; the power transmission assembly comprises a connection between the speed-changing output element of the speed-changing assembly and the speed-changing input element of the next-stage speed-changing assembly, and a connection between the speed-changing output element of the speed-changing assembly and the drum of the winch.

3. The winch with automatic speed-changing mechanism according to claim 1, wherein the speed-changing assembly is a planetary gear mechanism, comprising a sun gear, a ring gear, and a planet carrier; the speed-changing input element is the sun gear, and the speed-changing output element is the planet carrier or the ring gear.

4. The winch with automatic speed-changing mechanism according to claim 1, wherein the friction clutch control mechanism comprises an elastic element A, a combination feature, and a curved surface feature; the combination feature comprises a straight segment with a straight generatrix and/or a curved segment with a curved generatrix, the combination feature being configured such that when the elastic element A enters and/or leaves the curved segment, the elastic element A undergoes elastic deformation; the curved surface feature is configured to generate axial force during rotation.

5. The winch with automatic speed-changing mechanism according to claim 1, wherein the clutch device is a one-way clutch or an electromagnetically controlled locking pin device.

6. The winch with automatic speed-changing mechanism according to claim 2, wherein the contact clutch comprises a control bracket and a locking block; the control bracket is frictionally connected to the fixing member, the control bracket has a groove, an outer end of the locking block passes through the groove and is rotatable around an inner end of the locking block; the locking block is configured to simultaneously contact the power input component and the power output component so that the contact clutch is engaged when the locking block rotated to a first position, and configured not to contact the power output component or the power input component so that the contact clutch is disengaged when the locking block rotated to a second position.

7. The winch with automatic speed-changing mechanism according to claim 1, wherein the friction clutch comprises a friction plate, a pressure plate and an elastic element B, the elastic element B causes the pressure plate to press against the friction plate, and the pressure plate and the friction plate are respectively circumferentially fixedly connected to different components of the speed-changing assembly.

8. The winch with automatic speed-changing mechanism according to claim 1, wherein the fixing member comprises a housing of the winch fixedly installed, and parts directly or indirectly fixedly connected to the housing.

9. The winch with automatic speed-changing mechanism according to claim 2, wherein the contact clutch comprises a locking block and a return spring; the return spring causes the locking block to tend to move inward toward the power input component; the locking block is configured to simultaneously contact the power input component and the power output component so that the contact clutch is engaged when the locking block situated in an outer position, and configured not to contact the power output component or the power input component so that the contact clutch is disengaged when the locking block situated in an inner position.
